(19) United States
(12) Patent Application Publication
(10) Pub. No.: US 2014/0164160 A1
(43) Pub. Date: Jun. 12, 2014

(54) Method, System, Apparatus, and Program for Donation Driven Gift Fulfillment

(71) Applicant: Jonathan Forman, Mt. Vernon, NY (US)

(72) Inventor: Jonathan Forman, Mt. Vernon, NY (US)

(21) Appl. No.: 14/090,893

(22) Filed: Nov. 26, 2013

Related U.S. Application Data
(60) Provisional application No. 61/729,846, filed on Nov. 26, 2012.

(51) Int. Cl. G06Q 30/06

(52) U.S. Cl. CPC G06Q 30/0601
USPC 705/26.1

(57) ABSTRACT

The present invention generally relates to software driven, application (“app”)-based methods of gift giving, and more particularly to app-based methods for charitable donation-driven gift fulfillment via computing or mobile devices such as desktop, mobile, smartphones, and the like.

### CROSS REFERENCE TO RELATED APPLICATION

This application claims the benefit of U.S. Provisional Application No. 61/729,846, filed Nov. 26, 2012, the entire contents of which are hereby incorporated by reference, as if fully contained herein.

### BACKGROUND OF THE INVENTION

1. Field of the Invention

The present invention generally relates to software driven, application (“app”)-based methods of gift giving, and more particularly to app-based methods for charitable donation-driven gift fulfillment via computing or mobile devices such as desktop, mobile, smartphones, and the like.

2. Related Art

As known in the art, “smartphones” are a class of mobile phones or devices built on a mobile operating system (OS), with more advanced computing capability and connectivity than a feature phone. A mobile app is a software application designed to run on smartphones. Mobile apps are available through application distribution platforms, which are typically operated by the owner of the mobile operating' system. Usually, mobile apps are downloaded from the platform to a target device such as a smartphone, which can support many applications and programming languages. Mobile apps are also sometimes downloaded to less mobile computers, e.g., laptops or desktops, or to other computing or portable devices such as the iPod Touch.

There are known mobile social gift-giving apps that allow users to send gifts, i.e., to purchase and send gifts to friends and family directly from one's smartphone or mobile device, etc. However, there exists a need to provide a novel method for selecting a gift the giver is confident the recipient wants, generating charitable donations through a software-driven or app-based gift-giving system, providing incentive for retailers or vendors to participate in such a program, and for providing incentive to prospective gift purchasers using such a system to purchase through particular retailers or vendors.

### SUMMARY OF THE INVENTION

The present invention in one aspect provides a software driven, “app”-based method of generating substantial charitable donations while aiming to ensure that users can get an ideal gift, at a substantial discount, for the chosen recipient of the gift (e.g., a friend or relative), as well as for themselves. Of course, the present invention is not limited to app-based platforms, and can be implemented as a software program executed by any suitable computer or computing device and stored in, e.g., a computer-readable medium.

In one aspect of the present invention, “deals” or discounts may be negotiated with retailers/vendors/merchants and are then matched up with “registry” items on a recipient's list, e.g., a baby or wedding registry (or, absent a “registry,” with suggestions based on algorithmic processing of a recipient's “likes” or interests). A time-based deal window opens based on a significant event (e.g., a birthday, graduation, wedding, new baby arrival, etc.). A user can select an appropriate deal and, once a transaction is complete, can make a discounted purchase for himself or herself as well.

By virtue of this system, an initial percentage of the generated business revenue (e.g., 50% or any other percentage) can very quickly flow to charitable organizations. All management fees and overhead costs can be paid for by the remaining percentage of revenue. It is noted that “business revenue” refers to revenue to the company and not to the vendor/retailer/merchant, and “the company” refers to the entity that is implementing the methods described herein, as opposed to the vendors/retailers/merchants/etc.

The methods of the present invention are disclosed in more detail below. It is noted that the present invention anticipates using common operating systems (OS), both common and mobile. Common mobile operating systems (OS) in use include but are not limited to BlackBerry' s BlackBerry OS and BlackBerry 10, Google's Android, Apple's iOS, Nokia's Symbian, Samsung's Bada, Microsoft's Windows Phone, Hewlett-Packard's webOS, etc. Such operating systems (OS) can be installed on a number of different mobile product models, and typically each device can receive multiple OS software updates over its lifetime. The present invention can also operate with smart TVs, gaming consoles, future automotive platforms, and of course with laptops, desktops, iPods, tablets, and any other suitable computing device, whether mobile or otherwise.

The present invention according to one aspect provides a system of donation driven gift fulfillment. The system includes a database creation unit, adapted to create a database of available gift options each comprising a product or a service eligible to be purchased from a merchant by a user at a discount. The system also includes a notification unit, adapted to communicate at least one gift option to a user and informing the user that a percentage of the purchase price will go to charity. The system further includes a transaction unit, adapted to initiate a financial transaction, if the user chooses a gift option, for the purchase of the product or service identified by the gift option. The transaction unit initiates a financial transaction to transfer X% of the purchase price to the merchant, Y% to a charitable entity, and Z% to general revenue.

The present invention according to another aspect provides a method of donation driven gift fulfillment. The method comprises the steps, performed by a processor, of: (1) making an offer to a merchant to enable a user to purchase a product or service from the merchant at a discount with X% of the purchase price going to the merchant, Y% of the purchase price going to a charitable entity, and Z% of the purchase price going to general revenue; (2) creating a gift offer from an agreed-to deal with the merchant; (3) storing information relating to the gift offer in a database of available gift options; (4) communicating the gift offer to at least one user along with a notification that purchasing the gift will result in a charitable contribution; (5) initiating a financial transaction, if the user chooses a gift option, for the purchase of the product or service identified by the gift option; and (6) initiating a financial transaction to transfer X% of the purchase price to the merchant, Y% to a charitable entity, and Z% to general revenue.

The present invention according to another aspect provides a non-transitory computer-readable medium storing a program, which, when executed by at least one processor, causes the at least one processor to perform the steps of: (1) creating or accessing an online community of gift participants; (2) creating a database of available gift options comprising products and services based on deals agreed to with merchants which enable gift participants to purchase the products and services at a discount; (3) providing the gift participants with the option to create a wish list of desired gift options to be stored in a database and to view the wish lists of other gift participants; (4) creating or accessing a database containing personal information about the gift participants; (5) creating or accessing a database containing names of gift participants matched with eligible gift options tailored to individual gift participants based on at least one of wish list items, personal information, likes, and interests; (6) opening a time-based deal window to notify a gift participant of the eligible gift options along with a notification that a portion of the purchase price of the gift option would go to charity; (7) initiating a financial transaction, if the gift participant chooses a gift option, for the purchase of the product or service identified by the gift option; (8) initiating a financial transaction to transfer X% of the purchase price to the merchant, Y% to a charitable entity, and Z% to general revenue; and (9) closing the time-based deal window if the gift participant does not choose a gift option within a predetermined time period, further notifying the gift participants of eligible gifts, and returning to the first initiating step if the gift participant chooses another gift option.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will be more readily understood from a detailed description of the exemplary embodiments taken in conjunction with the following figures.

FIG. 1 is a diagram showing the overall environment that the present invention operates in according to one embodiment.

FIG. 2 is a diagram depicting a system for donation driven gift fulfillment according to an embodiment of the present invention.

FIG. 3 is a flow diagram of a method in accordance with an embodiment of the present invention.

FIG. 4 is a flow diagram of an example environment for electronically acquiring and downloading a gift mobile application (“gift app”) according to an embodiment of the present invention.

FIG. 5 is a flow diagram of a method in accordance with an example embodiment of the present invention.

The invention will next be described in connection with certain exemplary embodiments; however, it should be clear to those skilled in the art that various modifications, additions, and subtractions can be made without departing from the spirit or scope of the claims.

### DETAILED DESCRIPTION OF THE PREFERRED EMBODIMENTS

By virtue of the features of the present invention, an ideal gift can be found and purchased by a user of a computer, mobile device, smartphone, etc. Further, the purchaser can be provided with a benefit for purchasing the gift through a particular merchant. The benefit can be, for example, a discount, coupon, or voucher given to the purchaser and redeemable by the purchaser for a future gift from said merchant. Moreover, funds for charity can be more easily raised, specifically in connection with the purchase.

Accordingly, the present invention facilitates “giving” in order to “get.” It allows people to purchase gifts that are more tailored to the recipient's liking, due at least in part to the algorithm that makes use of the recipient's “likes,” or the registry, etc. It can solve much of the “sales force” problem that many “deal”-based companies have by providing a substantial incentive to charities to introduce new retailers/vendors/merchants to the company. Also, it may mitigate the extent of the “loss-leader” effect to the retailers/vendors/merchants/etc. by potentially allowing them to deduct a portion of the cost of the item as they are contributing to a non-for-profit organization. This allows for potentially larger discounts to users.

Accordingly, the present invention is built on a “Win⁴” concept:
1. The gift receiver wins.
2. The gift giver wins.
3. Charities win.
4. Businesses win.

As noted above, an app for the present invention can be for use with, e.g., the web or Internet, Facebook, Google+, Android, iOS, BlackBerry, WP8, and others.

Business Model

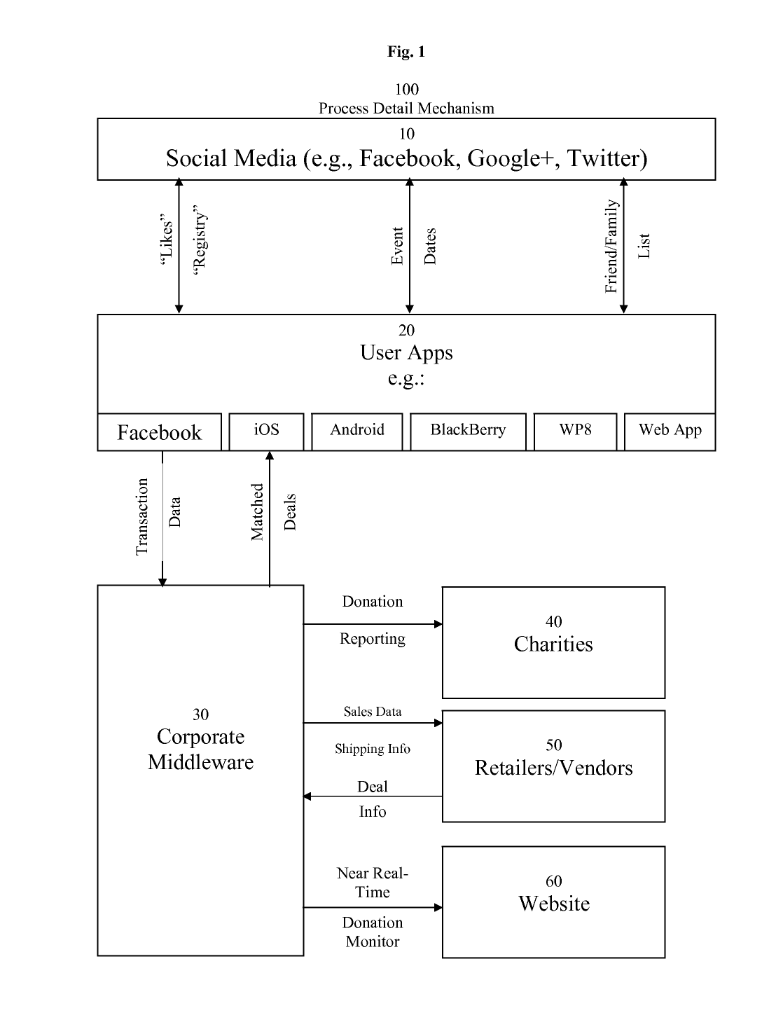

FIG. 1 is a diagram showing the overall environment 100 that the present invention operates in according to one example, and in particular how social media 10 (e.g., Facebook, Google+, Twitter) can interact with user apps 20 which may be controlled by corporate middleware 30 with connections to charities 40 and retailers/vendors/merchants 50. A website 60 is controlled by ‘the corporate middleware 30. Notable elements of a business model according to an aspect of the present invention are as follows.

First, a registry/deal system is built off of an app (e.g., a Facebook/Google+ app) that sources special events such as a birthday, wedding, anniversary, holiday, etc. The registry/deal system can also be built off of “like” or “interest” information from profiles of so- designated “friends.” An algorithm converts “likes” and interests or wish list information to eligible, appropriate gift options. The algorithm identifies products relating to a person's “likes,” interests, or wish list information and matches the identified products to eligible products being offered by participating merchants. Both the identified products and the eligible products can be stored in separate databases.

Second, “deals” can be negotiated with vendors, retailers, merchants, etc. and can be any percentage (e.g., 40%) off of suggested prices. One incentive for the vendor, retailer, or merchant is that they potentially make two immediate sales, one for the gift receiver and a second for the gift giver. Another incentive for the vendor, retailer, or merchant is that they can advertise their involvement in the charitable portion of the program to generate goodwill. They can also show a “counter” that counts up how many dollars have been contributed to charity thus far.

Third, the company splits revenue as follows (assuming a 50% discount to the buyer as an example):
An agreed-to percentage (50%) goes to the retailer or merchant;
A percentage (e.g., 50% of the remainder, or 25% of the total sale) is directly donated to a charity or charities:
   There are no management fees taken out of this percentage.
   There is no overhead reduction taken out of this percentage.
   The retailer or merchant can/will advertise their involvement in the program to generate goodwill.
      A percentage (e.g., 50% of the remainder, or 25% of the total sale) goes to expenses and profit;
      The retailer can potentially get significant savings on the difference between the original price and the deep discounted revenue they generate based on volume-based bonuses (resulting in the discount being as much as 40% less impactful to the retailer's bottom line).

Fourth, the software or app, which may be web-based, or run on Facebook, Google+, Android, iOS, BlackBerry, WP8, etc., carries out the following functions according to one aspect of the present invention.
Imports events and special occasions of “friends,” such as birthdays, anniversaries, holidays, etc.
Reminds user(s) in advance (e.g., a time period of 10 or 14 days) that an event is approaching.
   This opens a time-based “deal window” (e.g., 20 or 28 days, including 10 or 14 days before and 10 or 14 days after) during which users are offered a list of categorized deals including gifts the recipient is interested in as an incentive to purchase a gift.
Suggests gifts or gift categories the recipient may want based on:
   An app “registry” or wish list:
      Recipients can choose items they'd like to receive based on categories and specific items from partner retailers.
      By using the app, a user can see what their friends have on their lists.
      Users can create and share gift lists.
   A recipient's indicated “likes” or a user's interests.
   A recipient's previously purchased or owned products or items, or previously used services, or occupation or hobbies, wherein the system uses this information to predict or suggest other products or gifts the recipient might be interested in.
   A menu option is provided whereby people currently eligible are listed. Clicking on a person brings up their registry or suggested gifts.
Processes the user purchase of a gift for a recipient.
Give the option to the user to purchase a gift for himself or herself at a deal or discounted price; to make an additional charitable donation; or to do nothing more.
The deal window closes when the time deadline ends or when the gifts (one for the recipient and one for the user) are purchased. A user may always choose to make an additional charitable donation.
Remove the item or category, directly or facts and circumstances based, from the recipient's gift list or registry.

Thus, users can log into the system to create a registry of items they want. The registry can contain items made available by retailers who have agreed to participate. The items would identify the retailer within the catalog.

An algorithm scans a user's interests and “likes” on social media (e.g., Facebook page likes, Twitter following, hashtags with positive comments, Facebook posts and likes, etc.) and suggests items made available by participating retailers. For instance, if a user posts many status updates/tweets about participating in marathons, or likes running pages, the algorithm suggests running shoes/clothes, or training technology (e.g. heart rate monitors, GPS watches, fit bands, etc.).

As a public monitoring feature of the present invention, a corporate website of the company implementing this business model displays near real-time donation accumulation.

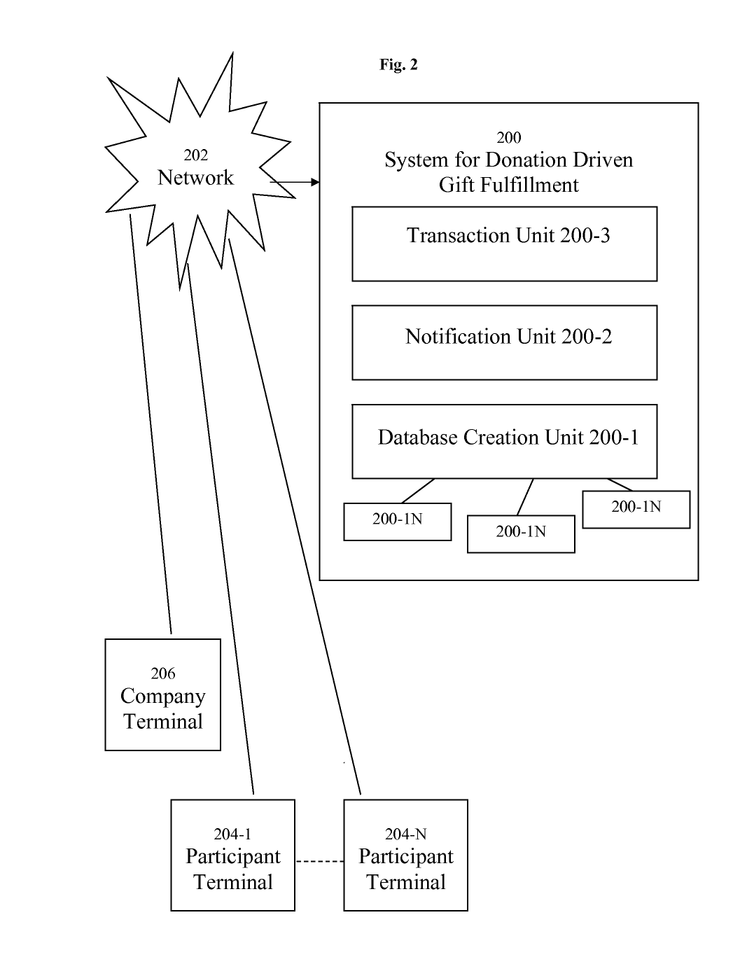

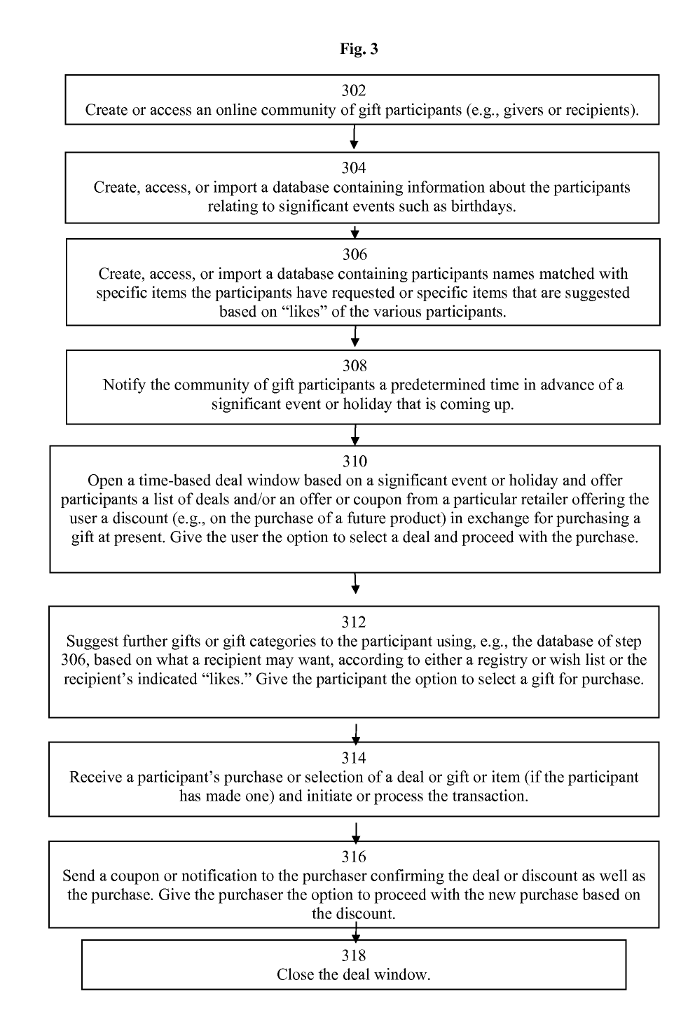

FIG. 2 is a diagram depicting a system 200 for donation driven gift fulfillment according to an embodiment of the present invention. The system 200 is an information processing system that enables the features of the present invention. The system 200 has a central processing unit (CPU), a memory, a browser, and a network interface to communicate through a network 202 (e.g., the Internet, Wi-Fi, an Intranet, etc.) with participant terminals 204-1 . . . 204-N (including user terminals or merchant terminals) and one or more company terminals 206 (where in this case the “company” refers to the entity that is implementing the business methods described herein and that may control the system 200). The system 200 includes a database creation unit 200-1 that creates, accesses, or imports one or more databases 200-1N. The databases 200-1N are further described below in connection with, e.g., steps 302-306 of the method 300 of FIG. 3. The system 200 also includes a notification unit 200-2 (see, e.g., steps 308-312 of FIG. 3) and a transaction unit 200-3 (see, e.g., steps 314-318 of FIG. 3).

FIG. 3 is a flow diagram of a method 300 in accordance with an exemplary embodiment of the present invention. The method 300 of FIG. 3 can be performed by an app or implemented by a computer device having a processor and a memory coupled to the processor for carrying out the steps of the method 300 or can be performed by system 200, etc.

In step 302, a community of gift participants is created or accessed (e.g., by the database creation unit 200-1 of FIG. 2). The community may be an online community and comprises persons who may be gift givers and/or receivers. Also as part of this step users may be provided with the option to create a wish list or registry of gift items they are interested in for themselves, e.g., by choosing from a database of available gift options, or “liking” gift items or other items from other peoples' pages, etc. Keywords from this information can be stored in a database.

In step 304, a database is created, accessed, or imported (e.g., by the database creation unit 200-1) containing information about the participants relating to at least one of birthdays, wedding dates, baby arrival dates, graduation dates, anniversary dates, etc., information relating to holidays/etc.

In step 306, a database is created, accessed, or imported (e.g., by the database creation unit 200-1) containing participants names matched with specific items the participants have requested (e.g., registry) or specific items that are suggested based on “likes,” interests, or profiles of the various participants, or based on previous products/services purchased or previous gifts received. An algorithm periodically converts “likes,” interests, etc. to eligible, appropriate gift options (e.g., by matching keywords of the likes and interests to keywords of stored available gift options). The algorithm identifies keywords relating to a person's “likes,” interests, profile information, posting information, events, previously purchased items, etc., and matches the identified keywords to eligible products being offered by participating vendors, retailers, merchants, etc. Deals negotiated with or agreed to by a merchant can be stored in a dedicated database of available gift options (updated periodically) along with keywords describing it, and matched to keywords in the database containing the participant information to suggest it as a gift. (For this step a database can be created or matched gift ideas can be created and pushed out to users periodically.)

In step 308, a gift participant is notified (e.g., by the notification unit 200-2) a predetermined time period in advance (e.g. 10 days hence) of a significant event that is coming up. This can be, for example, a birthday or graduation of a specific participant (potential gift recipient who is a friend or contact, etc.), or a holiday which may pertain to the community at large, etc. Gift participants can also be provided at any time (whether prompted by a significant event or unprompted, or requested by the user) with a list of available gift options to choose from.

In step 310, a time-based deal window is opened (e.g., by the notification unit 200-2) based on a significant event. During this deal window, participants are offered a list of deals as an incentive to purchase a gift. A list of deals can be shown to the participants, as well as an offer or coupon from a particular vendor/retailer/merchant offering the user a discount (e.g., on the purchase of the current product for the gift recipient and/or a product for the gift purchaser) in exchange for purchasing a gift at present. The user can also be informed that a portion of the purchase price will go to charity. The user is given the option to select a deal and proceed with the purchase.

In step 312, if the participant within a predetermined time period still hasn't selected a gift or deal, further gifts or gift categories can optionally be suggested to the participant (e.g., by the notification unit 200-2) using, e.g., the database of step 306, based on what a recipient may want, according to either a registry or wish list or the recipient's indicated “likes,” etc. The participant is given the option to select a gift for purchase.

In step 314, a participant's purchase or selection of a deal or gift or item is received (if the participant has made one), and the transaction is initiated or processed (e.g., by the transaction unit 200-3) using known online purchase methods.

In step 316, a notification is sent (e.g., by the transaction unit 200-3) to the purchaser confirming the deal or discount as well as the purchase.

In step 318, the deal window is closed (e.g., by the transaction unit 200-3) due to, e.g., the completion of the gift purchase or the elapse of the time deadline. The item or gift may be removed from the participant's gift list.

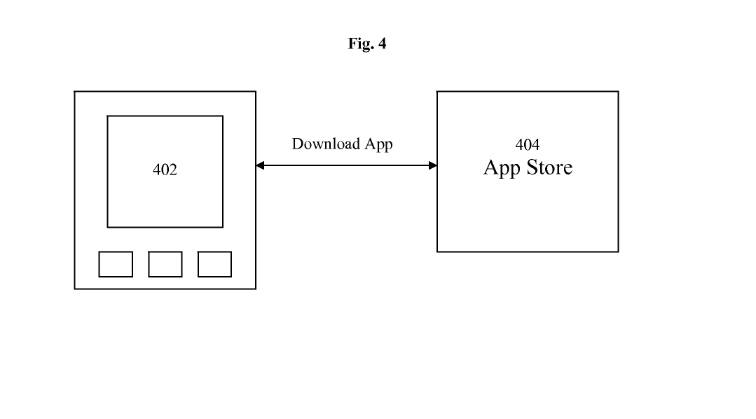

FIG. 4 depicts a flow diagram of an exemplary environment 400 for electronically acquiring and downloading a gift mobile application (“gift app”) according to an embodiment of the present invention. In one embodiment, environment 400 may include a portable computing device 402 and an application store 404. The application store 404 is marked to generally represent any mobile application store, but it is to be understood that the actual identity of the application store 404 is dependent on the operating system downloading the gift app.

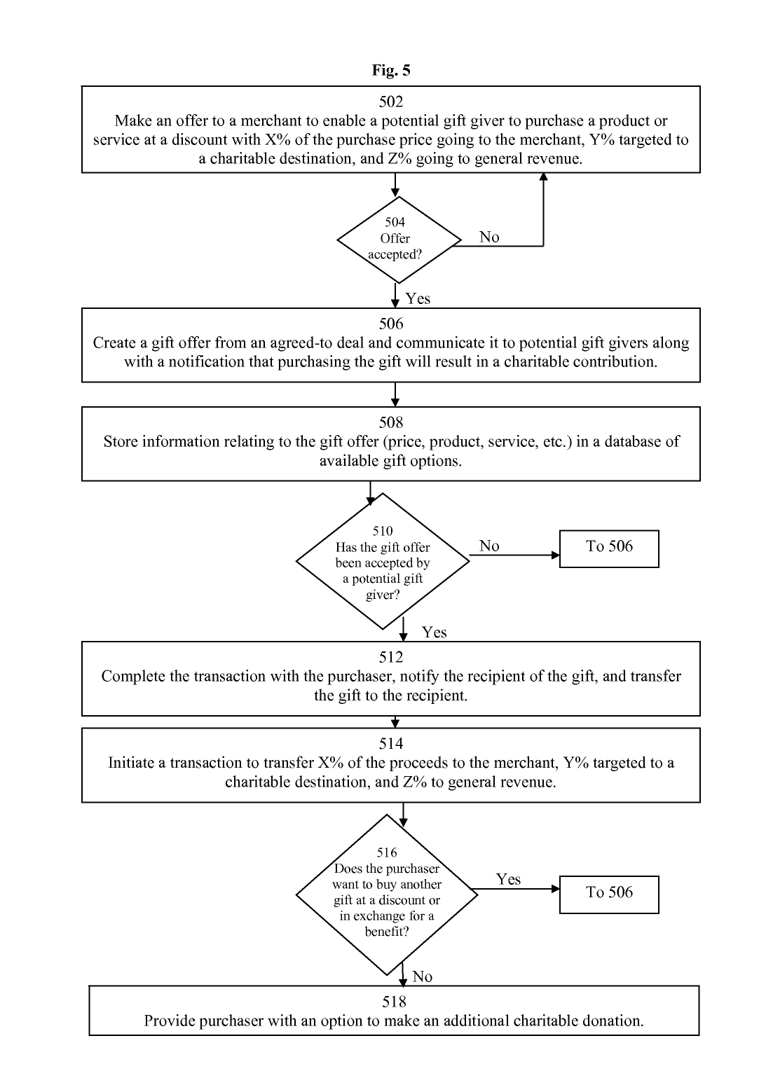

FIG. 5 is a flow diagram of a method 500 in accordance with an example embodiment of the present invention. The method 500 of FIG. 5 can be implemented by a computer device having a processor and a memory coupled to the processor for carrying out the steps of the method 500 or can be performed by systems 100 or 200, etc.

In step 502, an offer is made to a merchant (or vendor or retailer) which would enable a user or gift giver to purchase a product or service from the merchant as a gift for a gift recipient, wherein the product or service will be purchased (by the user or gift giver) at a discount, with X% (e.g., 50%) of the purchase price going to the merchant, Y% (e.g., 25%) of the purchase price targeted to a charitable destination, and Z% (e.g., 25%) of the purchase price going to general revenue. This step could be performed by the system 200 (e.g., the database creation unit 200-1), which automatically pushes out offers to merchants based on the above. Alternatively, deals could be negotiated separately and then the agreed to products or services later added to the database of available gifts.

In step 504, if the offer made in step 502 is accepted such that a deal is agreed to with the merchant (“YES”), the method proceeds to step 506. Otherwise, step 502 is repeated.

In step 506, a gift offer is created from the agreed-to deal and is communicated (e.g., by the notification unit 200-2) to a potential gift giver or gift givers. For example, the gift offer can be matched up with “registry” items on a recipient's list, or suggested to friends of the recipient based on the recipient's list or on algorithmic processing of the recipient's likes or interests or previous purchases or gifts. A time-based deal window can for example be opened up for potential gift givers. A notification that purchasing the gift or service will result in a charitable contribution can be communicated to the potential gift giver as well. The gift offer may be communicated either in a specific message to a potential gift giver, or in a listing of available gift ideas, etc. Gift offers or suggestions including this specific offer and/or others may be communicated to potential gift givers in a list or based on timeline events, likes, interests, etc.

In step 508, information relating to the gift offer (price, product, service, etc.) is stored in a database of available gift options (e.g., by the database creation unit 200-1).

In step 510, it is determined (e.g., by the transaction unit 200-3) whether a gift offer communicated in step 506 has been accepted by a potential gift giver.

If the gift offer communicated in step 506 is accepted (“YES”), then in step 512 the method proceeds (e.g., through the transaction unit 200-3) to complete the transaction with the purchaser, notify the recipient of the gift, and transfer the gift to the recipient. If the gift offer communicated in step 506 is not accepted (“NO”), then another gift offer can be communicated (e.g., by the notification unit 200-2) to the purchaser or the purchaser can be returned to a listing of available gifts.

In step 514 a transaction is initiated (e.g., by the transaction unit 200-3) to transfer X% of the proceeds to the merchant, Y% of the proceeds targeted to a charitable destination, and Z% of the proceeds to general revenue. The for-profit entity can handle management fees and overhead costs.

In step 516, the purchaser is provided (e.g., by the notification unit 200-2) with the opportunity to buy another gift for someone at a discount (similar to the previous gift offer or so that the user can see a list of available gift options) or in exchange for a benefit. If the purchaser chooses to do this the method returns to step 506. If not then in step 518 the user is given the opportunity to make a further charitable donation.

It is noted that in addition to the methods described herein there can be provided a transparent automatic gauge where someone can see or look up what a particular merchant or retailer or vendor company has raised for charity through this program. This provides incentive to companies to participate in the program, not only to give to charity but as a marketing tool to advertise that fact.

The present invention or any part(s) or function(s) thereof, including, e.g., the system for donation drive gift fulfillment 200, the database creation unit 200-1, the notification unit 200-2, the transaction unit 200-3, the participant terminals 204-1 . . . 204-N, and the company terminal 206, and the portable computing device 402 may be implemented using hardware, software, or a combination thereof, and may be implemented in one or more computer systems or other processing systems. A computer system for performing the operations of the present invention and capable of carrying out the functionality described herein can include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the invention using other computer systems and/or architectures.

The computer system can include a display interface that forwards graphics, text, and other data from the communication infrastructure (or from a frame buffer) for display on a display unit. The display interface can communicate with a browser. The computer system also includes a main memory, preferably a random access memory, and may also include a secondary memory and a database. The secondary memory may include, for example, a hard disk drive and/or a removable storage drive, representing a floppy disk drive, a magnetic tape drive, an optical disk drive, etc. The removable storage drive reads from and/or writes to a removable storage unit in a well known manner. The removable storage unit can represent a floppy disk, magnetic tape, optical disk, etc. which is read by and written to by the removable storage drive. As will be appreciated, the removable storage unit can include a computer usable storage medium having stored therein computer software and/or data.

The computer system may also include a communications interface which allows software and data to be transferred between the computer system and external devices. The terms “computer program medium” and “computer usable medium” are used to refer generally to media such as the removable storage drive, a hard disk installed in the hard disk drive, and signals. These computer program products provide software to the computer system.

Computer programs or control logic are stored in the main memory and/or the secondary memory. Computer programs may also be received via the communications interface. Such computer programs or control logic (software), when executed, cause the computer system or its processor to perform the features and functions of the present invention, as discussed herein.

“Mobile Application” or “Mobile App” or “App” as used herein, include, but are not limited to, applications that run on smart phones, tablet computers, and other mobile, portable, or suitable computing devices including laptops or desktops (as noted above, mobile apps are also sometimes downloaded to less mobile computers, e.g., laptops or desktops, or to other computing or portable devices such as the iPod Touch). The terms “Mobile Application” or “Mobile App” or “App” can be used synonymously with “software.” Mobile apps enable users to connect to services which are traditionally available on the desktop or notebook platforms. Typically, these services access the Internet or intranet or cellular or wireless fidelity (Wi-Fi) networks, to access, retrieve, transmit, and share data.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above- described exemplary embodiments, but should be defined only in accordance with the following claims and their equivalents.

In addition, it should be understood that the Figures illustrated in the attachments, which highlight the functionality and advantages of the present invention, are presented for example purposes only. The architecture of the present invention is sufficiently flexible mid configurable, such that it may be utilized (and navigated) in ways other than that shown in the accompanying figures.

What is claimed is:

1. A system of donation driven gift fulfillment, comprising:
a database creation unit, adapted to create a database of available gift options each comprising a product or a service eligible to be purchased from a merchant by a user at a discount;
a notification unit, adapted to communicate at least one gift option to a user and informing the user that a percentage of the purchase price will go to charity; and
a transaction unit, adapted to initiate a financial transaction, if the user chooses a gift option, for the purchase of the product or service identified by the gift option,
wherein said transaction unit initiates a financial transaction to transfer X% of the purchase price to the merchant, Y% to a charitable entity, and Z% to general revenue.

2. The system of claim 1, wherein said notification unit is further adapted to notify a gift recipient of the gift.

3. The system of claim 1, wherein said notification unit is further adapted to offer the user the option to buy another gift at a discount or in exchange for a benefit.

4. The system of claim 1, wherein said transaction unit is further adapted to provide the user with an option of making an additional charitable donation.

5. A method of donation driven gift fulfillment comprising the steps, performed by a processor, of:
making an offer to a merchant to enable a user to purchase a product or service from the merchant at a discount with X% of the purchase price going to the merchant, Y% of the purchase price going to a charitable entity, and Z% of the purchase price going to general revenue;
creating a gift offer from an agreed-to deal with the merchant;
storing information relating to the gift offer in a database of available gift options;
communicating the gift offer to at least one user along with a notification that purchasing the gift will result in a charitable contribution;
initiating a financial transaction, if the user chooses a gift option, for the purchase of the product or service identified by the gift option; and
initiating a financial transaction to transfer X% of the purchase price to the merchant, Y% to a charitable entity, and Z% to general revenue.

6. The method of claim 5, further comprising the step of notifying a gift recipient of the gift.

7. The method of claim 5, further comprising the step of offering the user the option to buy another gift at a discount or in exchange for a benefit.

8. The method of claim 5, further comprising the step of providing the user with an option of making an additional charitable donation.

9. A non-transitory computer-readable medium storing a program, which, when executed by at least one processor, causes the at least one processor to perform the steps of:
creating or accessing an online community of gift participants;
creating a database of available gift options comprising products and services based on deals agreed to with merchants which enable gift participants to purchase the products and services at a discount;
providing the gift participants with the option to create a wish list of desired gift options to be stored in a database and to view the wish lists of other gift participants;
creating or accessing a database containing personal information about the gift participants;
creating or accessing a database containing names of gift participants matched with eligible gift options tailored to individual gift participants based on at least one of wish list items, personal information, likes, and interests;
opening a time-based deal window to notify a gift participant of the eligible gift options along with a notification that a portion of the purchase price of the gift option would go to charity;
initiating a financial transaction, if the gift participant chooses a gift option, for the purchase of the product or service identified by the gift option;
initiating a financial transaction to transfer X% of the purchase price to the merchant, Y% to a charitable entity, and Z% to general revenue; and
closing the time-based deal window if the gift participant does not choose a gift option within a predetermined time period, further notifying the gift participants of eligible gifts, and returning to the first initiating step if the gift participant chooses another gift option.
